(19) United States
(12) Patent Application Publication
(10) Pub. No.: US 2026/0232520 A1
(43) Pub. Date: Aug. 13, 2026

(54) COMPACT TREKKING CRUTCH

(71) Applicant: DQCW, LLC, Yakima, WA (US)

(72) Inventor: Mark Koday, Yakima, WA (US)

(21) Appl. No.: 19/050,986

(22) Filed: Feb. 11, 2025

(51) Int. Cl. A61H 3/02; A45B 9/02

(52) U.S. Cl. CPC A61H 3/0288; A45B 9/02; A45B 2200/05; A61H 2003/0205

(57) ABSTRACT

A trekking crutch, useful as an emergency hiking aid, which is light in weight and easily disassembled and re-assembled. The trekking crutch includes exchangeable elements that can be packed or stowed compactly, providing a hybrid crutch having trekking or hiking pole features that is quickly assembled without the use of tools. The trekking crutch includes an underarm member with a cushioned underarm cross-bar. The underarm member connects removably to a handle member that has a graspable handgrip, and the handle member removably connects to a lower end member of the trekking crutch and is replaceable with a conventional trekking, hiking, downhill or cross-country ski pole handle. The lower end member can receive a lower pole element into a lower pole mount. The lower pole element is preferably a standard pole end, and can include a conventional ski-tip with a basket.

### TECHNICAL FIELD

The present disclosure to an apparatus for a trekking crutch, specifically an emergency hiking aid, which is light-in-weight and easily modified to suit the needs of a user. The trekking crutch includes exchangeable elements that can be packed or stowed compactly, providing a hybrid crutch having trekking or hiking pole features that is quickly assembled or disassembled without the use of tools.

### BACKGROUND OF THE INVENTION

There is limited or no cell phone service in most wilderness and mountainous areas. Hikers in these areas must rely on satellite phones for aid, depend on help from others in emergency situations, or simply must be self reliant when problems occur and help or rescue assistance is needed. Typical outdoor adventurers start a climb or hike believing they will return to their trailhead or return destination tired at the worst, but otherwise healthy and mobile. Also, many individuals attempt solo hikes, which could be life endangering even with a moderate ankle or knee sprain, but even hiking with a partner is no guarantee of a ‘hike out’ in case of an immobilizing leg injury.

In a 2011 study published in the American Journal of Orthopedics, Trauma and Rehabilitation, reported an incident rate of almost 10% for sprained ankles by typical hikers. These incidents occur most commonly hiking on loose gravel or ‘scree’, and on downhill slopes. “How-to” types of hiking articles and videos discuss and show methods of treating a sprained or broken ankle or leg, but seldom how to walk or be independently mobile after such an injury. Furthermore, most of these remedies or treatments are impractical in the field.

Without a crutch or supportive hiking partner, and if far from possible access by a vehicle, the hiker is stranded and alone, and soon may be a victim of exposure to the elements, which compounds the emergency. Hiking back to a far-away trailhead is physically demanding, even with a hiking partner. This could be impossible if, for example, the injury involves larger, injured person with a smaller hiking partner. If the hiking partner leaves the injured hiker to get help, this could delay aid considerably. Harsh or inclement weather conditions could make this a dangerous situation.

Bringing a full crutch on a hike is not possible, so there is a need for an easily disassembled and light-weight crutch for hikers, trekkers, and climbers. Ideally, such a crutch could be attached to or stowed within a day pack or backpack with ease, while adding little additional weight and taking up a minimum of room inside or on the exterior of the pack.

Therefore, the present invention as disclosed herein addresses these needs for an emergency crutch that is useful for hikers and trekkers, with inventive features that will be better understood by reference to the following detailed description taken in conjunction with the accompanying drawings.

### BRIEF DESCRIPTION OF THE DRAWINGS

Exemplary embodiments of the present invention will become more fully apparent from the following descriptions and appended claims, taken in conjunction with the accompanying drawings. Understanding that these drawings depict only exemplary embodiments and are, therefore, not to be considered limiting of the scope of the present invention, with the exemplary embodiments described with additional specificity and detail through use of the accompanying drawings in which:

FIG. 1 is a front view of a trekking crutch, according to an embodiment of the invention;

FIG. 2 is a front view of a portion of a trekking crutch, according to an embodiment of the invention;

FIG. 3 is a front view of a portion of a trekking crutch, according to an embodiment of the invention;

FIG. 4 is a front view of a portion of a trekking crutch, according to an embodiment of the invention;

FIG. 5 is a front view of a portion of a trekking crutch, according to an embodiment of the invention;

FIG. 6 is a side view of a trekking crutch, according to an embodiment of the invention;

FIG. 7 is a frontal view of a user with a trekking crutch, according to an embodiment of the invention; and

FIG. 8 is a side view of a user with a trekking crutch, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations. Details that are not necessary for an understanding of the present invention by one skilled in the technology of the invention, or render other details difficult to perceive, may have been omitted.

### DETAILED DESCRIPTION OF SPECIFIC EMBODIMENTS

The present disclosure relates to and is applicable to a trekking pole emergency hiking aid with exchangeable elements that provides for a quick and simple conversion of the trekking pole to function as a crutch, without the use of tools. More simply, the trekking crutch apparatus of the present invention may be referred to herein more simply as a “trekking crutch”, and when disassembled, the trekking crutch is light in weight and compact, and easily packed or stowed for emergency use.

The apparatus elements and operational steps employed in the trekking crutch, as described and illustrated herein, could be executed, arranged, and designed in a variety of different configurations or inter-convertible embodiments. Thus, the following detailed description of alternative embodiments of the trekking crutch of the present invention along with preferred elements of its apparatus and its operation are not intended to limit the scope of the invention, as claimed, but merely representative of exemplary embodiments of the technology. With the present disclosure and technical description of the trekking crutch provided herein by way of example, it also should be noted that other similar configurations and components could be utilized in alternative embodiments of elements of the trekking crutch of the present invention and in alternative operational steps. Therefore, exemplary embodiments of elements of the trekking crutch and its operation will be best understood by reference to the drawings included herewith, with like parts designated by like numerals throughout.

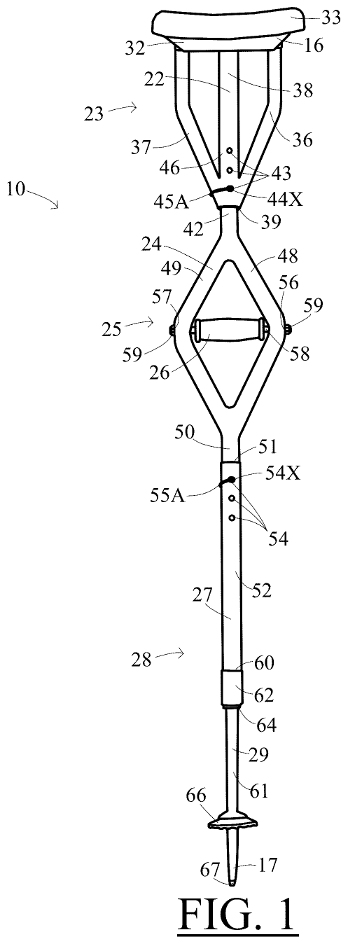

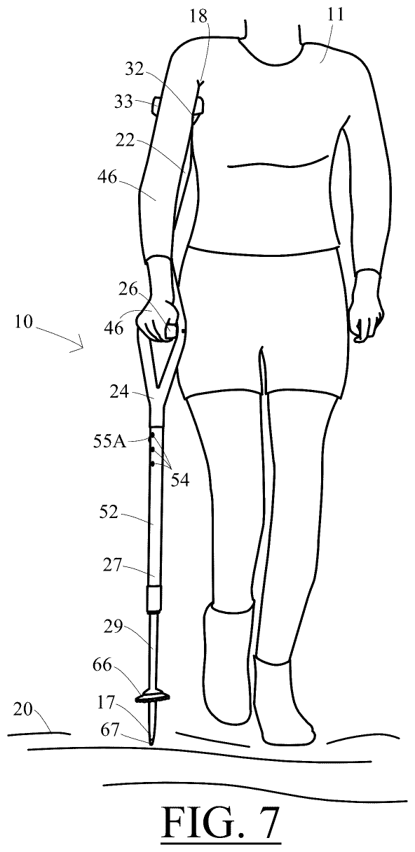

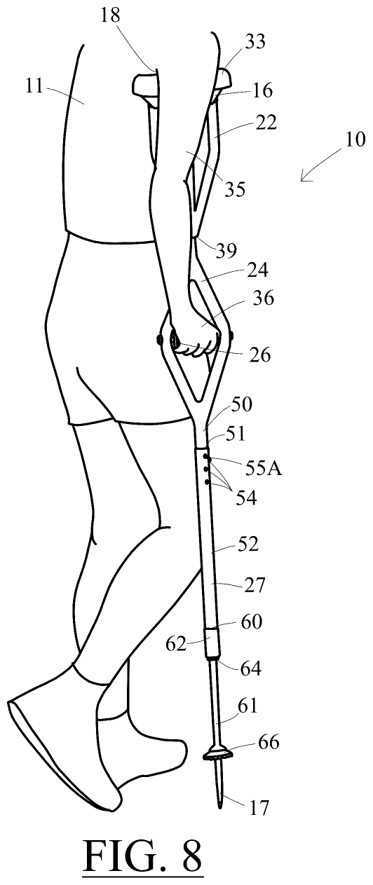

The present invention provides for the trekking crutch 10, with FIGS. 1 through 8 showing selected preferred embodiments and components of the trekking crutch, with FIGS. 7 and 8 showing the trekking crutch employed to support a user 11.

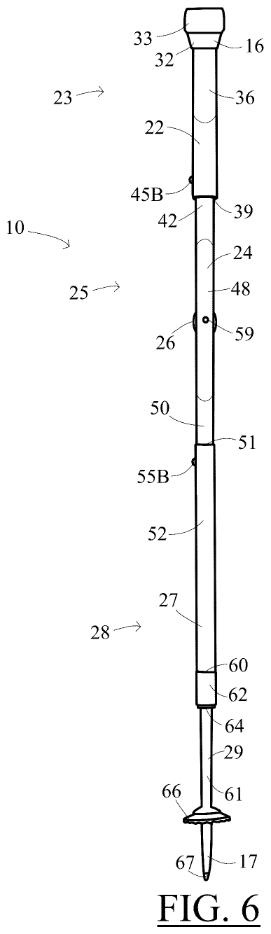

FIG. 1 shows the trekking crutch 10 as preferably assembled and ready for use as a crutch device. When fully assembled and in position for use, the trekking crutch has a proximal end 16 above and opposite a distal end 17. The proximal end is receivable into an armpit 18 of the user 11, and the distal end contacts a ground surface 20 to support the user, as shown in FIG. 6. An underarm member 22 of the trekking crutch is positioned at the proximal end, in an upper position 23. The underarm member connects to a handle member 24 of the trekking crutch, with the handle member in a middle position 25 along the trekking crutch, and with the handle member including a handgrip 26 that the user can grasp, as shown in FIGS. 6 and 7. The handle member connects to a lower end member 27 of the trekking crutch, with the lower end member in a lower position 28 proximate to the distal end of the trekking crutch, and with the lower end member including a ground contact element 29.

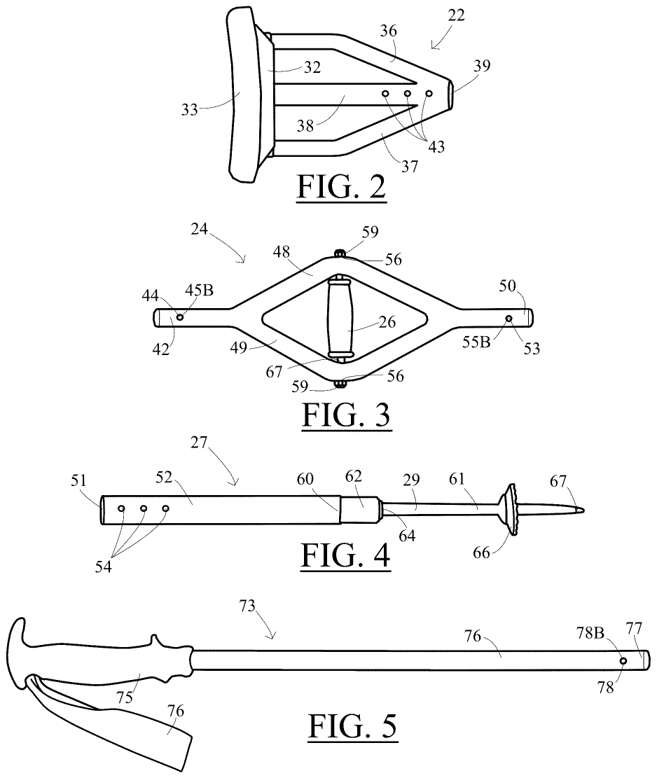

FIGS. 2 through 4 show components of the trekking crutch 10, with FIG. 2 detailing the underarm member 22 as having an underarm cross-bar 32 with an underarm cushion 33 mounted on the underarm cross-bar. The underarm cushion may be made of any conventional cushion material as well known to those skilled in selecting typical cushion materials, including closed cell memory foam, gel, rubber, elastomeric, or thermoplastic. The underarm cushion is selected to cap the underarm cross-bar and provide cushioned support of the user 11 at the armpit 18 of the user, as shown in FIGS. 7 and 8.

The underarm cross-bar 32 of the underarm member 22 is supported by an underarm first side support-bar 36, opposite an underarm second side support-bar 37. The underarm first side support-bar and the underarm second side support-bar join below the underarm cross-bar at an underarm sleeve 39, specifically with the underarm first side support-bar and the underarm second side support-bar extending from the underarm cross-bar and joining together at the underarm sleeve.

Preferably, as shown in FIG. 2, an underarm center support-bar 38 is positioned between the underarm first side support-bar and the underarm second side support-bar, with the underarm center support-bar including the underarm sleeve 39. To assemble the underarm member 22 to the handle member 24, the underarm sleeve can receive an upper neck-post 42 from the handle member as shown in FIGS. 1 and 6, or to disassemble the underarm member from the handle member the upper neck-post can be removed from the underarm sleeve of the underarm member, as shown separated in FIGS. 2 and 3.

Most preferably, the underarm center support-bar 38, the underarm first side support-bar 36, and the underarm second side support-bar 37 are formed from a tubular material, and most preferably an aircraft quality aluminum tubing having a round cross-section. The tubular material, simply referred to as “tubing” can be bent to the needed radius and joined with welds, preferably using either a “MIG”, or a “TIG” welding system as are well known to those skilled in the welding of aluminum tubes, though TIG is preferred for typically stronger welds joining aluminum tubing.

Again, the upper neck post 42 of the handle member 24 is removably receivable into the underarm sleeve 39, and furthermore receivable into the underarm center support-bar 38 of the underarm member 22. Importantly, the underarm member and the handle member of the trekking crutch 10 are readily and easily either assembled or disassembled, as herein termed “removably connectable”. Preferably, the underarm center support-bar includes a set of underarm coupling holes 43, as shown in FIG. 2, and the upper neck-post includes an upper handle coupling hole 44 as shown in FIG. 3. Preferably, when received into the underarm sleeve, the upper handle coupling hole aligns with or “lines-up” with one of the set of underarm coupling holes, as shown in FIG. 1, to form an upper aligned hole-pair 44X.

An upper spring-clip 45A, or in the alternative an equivalent pin or post, can be inserted through the matched-up holes of the upper aligned hole-pair 44X to secure the attachment between the underarm member and the handle member. By selecting which one of the set of underarm coupling holes 43 to match up with the upper handle coupling hole 44 and received the insertion of the upper spring-clip, the combined length of the underarm cross-bar 32 and the handle member 24 can be selected initially or later adjusted to best suit the user 11 of the trekking crutch 10.

Specifically, as shown in FIGS. 7 and 8, the armpit 18 of the user receives the underarm cross-bar 32, with an arm 46 of the user 11 positioned substantially parallel to the trekking crutch 10, so that a hand 47 of the user can grasp the handgrip 26 of the handle member 24. The handgrip of the handle member is attached between a first hand-bar 48 and a second hand-bar 49, as shown in FIGS. 1 and 3, with the handgrip formed from a conventional rubber or elastomeric material, preferably with grooves or a cross-hatched pattern for improving the grasp of the hand of the user on the handgrip.

The first hand-bar 48 and the second hand-bar 49 of the handle member 24 join together at the upper neck-post 42, and then diverge below the upper handle coupling hole 44 to accommodate the handgrip 26. Below the handgrip of the handle member, as shown in FIG. 1, the first hand-bar and the second hand-bar converge and join together to form a lower neck post 50. The lower neck sleeve receives a lower neck sleeve 51 of a lower pole-bar 52 that is part of the lower end member 27, with the lower pole-bar received onto and attached to the lower neck post of the handle member.

Additionally, the handle member 24 and the lower end member 27 of the trekking crutch 10 are readily and easily either assembled together or disassembled, again as herein termed “removably connectable”. Specifically, the lower neck post 50 of the handle member 24 is removably received into the lower neck sleeve 51 and further into the lower pole-bar 52 of the lower end member 27. Preferably, the lower pole element includes a set of lower bar coupling holes 54 as shown in FIG. 1 and. 4, and the lower neck-post includes an lower handle coupling hole 53 as shown in FIG. 3. When received into the lower neck sleeve, the lower handle coupling hole aligns with or “lines-up” with one of the set of lower bar coupling holes, as shown in FIG. 1, to form a lower aligned hole-pair 54X.

A lower spring-clip 55A, or in the alternative an equivalent pin or post, can be inserted through the matched-up holes of the lower aligned hole-pair 54X to secure the attachment between the lower end member and the handle member, also as shown in FIG. 1. By selecting which one of the set of lower element coupling holes 54 to match up with the lower handle coupling hole 53 and received the insertion of the lower spring-clip, the combined length of the handle member 24 and the lower pole-bar 52 and can be selected initially, or later adjusted to best suit the user 11 of the trekking crutch 10, especially in relation to the ground contact element 29.

As an alternative to the use of the upper spring-clip 45A to secure the attachment of the underarm member 22 to the handle member 24, the upper neck post 42 of the handle member can include an upper handle spring button 45B that would be located proximate to the location shown in FIG. 3 for the upper handle coupling hole 44. When the upper neck post of the handle member is received into the underarm neck sleeve 39, the upper handle spring button is initially depressed to slide into the underarm neck sleeve, and then the upper handle spring button extends or “pops-up”, to lock the handle member into the underarm member, as shown in FIGS. 1 and 6.

Similarly, as an alternatively to the use of the lower spring-clip 55A to secure the attachment of the lower end member 27 to the handle member, the lower neck post 50 of the handle member can include a lower handle spring button 55B that would be located proximate to the location shown in FIG. 3 for the lower handle coupling hole 53. When the lower neck post of the handle member is received into the lower neck sleeve, the lower handle spring button is initially depressed to slide into the lower neck sleeve, and then the lower handle spring button extends or “pops-up”, to lock the handle member into the lower end member, also as shown in FIGS. 1 and 6.

The lower pole-bar 52 and the ground contact element 29 together form the lower end member 27 of the trekking crutch 10, as shown in FIG. 4. Preferably, the ground contact element comprises a pole end element 61 that is a typical lower end or bottom portion of a conventional trekking pole or a ski pole, as commonly available for use by hikers, trekkers, skiers, and climbers. Most specifically, the pole end element is most preferably an end or bottom portion of a ski pole, with such segmented and extendable or retractable “telescoping” types of poles as typically available and known to those skilled in outdoor poles and pole types of aids.

The pole end element 61 is received into and mounted into the lower pole-bar 52 at a lower pole-bar end 60 of the lower pole-bar at a lower pole mount 62. As shown in FIG. 4, the lower pole-bar end is at the opposite end of the lower pole-bar from the lower neck sleeve 51 of the lower pole-bar. Preferably, the lower pole mount is permanently attached or affixed to the lower pole-bar at lower pole-bar end, and the permanent attachment can be a glue, a weld, a crimp, a screw or a rivet, or any other conventional attachment.

The lower pole mount 62 can be any typical clamp type of receiver mount, as commonly found on telescoping ski poles and trekking or hiking poles and walking sticks. Preferably, the ground contact element includes an expanding connection mount 64 that is received into the lower pole mount. The expanding connection mount is a common internally expanding or contracting type of receiver mount, which twists or rotates to selectively tighten if the ground contact element is twisted to the right or clockwise direction in relation to the lower pole-bar 52, or loosens if the ground contact element is twisted to the left or counter-clockwise in relation to the lower pole-bar. Alternatively, external “flip-lock” types of locking connectors could also be employed as the lower pole mount, or any other connector as known to those skilled in the manufacture of adjustable length hiking, skiing, and trekking poles.

The pole end element 61, as the most preferred ground contact element 29, and is receivable into and mounted within the lower pole mount 62, to form the lower end member 27 at the lower position 25 of the trekking crutch 10, as shown in FIG. 4. The pole end element preferably includes a ski-basket 66 with an end tip 67, as shown in FIG. 1, and 4. The end tip is the portion of the ground contact element that meets the ground surface 20, as shown in FIG. 7.

As an optional configuration of the trekking crutch 10, a ski pole handle member 73, as shown in FIG. 5, can be used as a substitute for the handle member 24. The ski pole handle member can be the handle portion of any typical hiking or trekking pole, a downhill or “alpine” type of ski pole, or a cross county or “nordic” type of ski pole, as may need to be modified to have a lower ski handle connector post 77 on a ski-pole segment 76 of the ski pole handle member. An upper grip 75 is also mounted on the ski-pole segment 76 opposite the lower ski handle connector post, with a ski handle connector hole 78 located proximate to the lower ski handle connector post.

When it is needed or desired to convert the trekking crutch 10 into a functional ski or hiking type of pole, or to convert the ski/hiking pole back into the trekking crutch, the handle member 24 of the assembled trekking crutch can be exchanged or “swapped-out” with the ski pole handle member 73. As can be selected for the handle member, the user 11 may select which one of the set of lower element coupling holes 54 on the lower pole-bar 52 of the lower end member 27 to match up with the ski handle connector hole 78 and receive the insertion of the lower spring-clip 55A.

With this optional alternative selection feature, the combined length of the lower end member 27 and the ski pole handle member 73 and can be selected initially or later adjusted to best suit the user 11, especially in relation to distance between the upper grip 75 to ground contact element 29. For this optional configuration, the lower ski handle connector post 77 on the ski pole segment 76 of ski pole handle member is received into the lower neck sleeve 51 of the lower end member 27, instead of the lower neck post 50 of the handle member being received into the lower neck sleeve.

Also, as an alternatively to the use of the lower spring-clip 55A to secure the optional alternative attachment of the ski pole handle member 73 to the lower end member 27, a ski handle spring button 78B can be included near the lower ski handle connector post 77 of the ski pole handle member, and located on the ski pole segment 76 proximate to the location shown in FIG. 5 for the ski handle connector hole 78. When the lower ski handle connector post 77 of the ski pole handle member is received into the lower neck sleeve 51 of the lower end member, the lower spring button is initially depressed to slide into the lower neck sleeve, and then the lower spring button extends or “pops-up”, to lock the handle member into the lower end member.

In a most preferred embodiment of the trekking crutch 10, the underarm member 22, the handle member 24, and the lower pole-bar 52 of the lower end member 27 are formed substantially, of a hollow cylindrical tubing alternatively and oval or of a squared tubing, which is preferably an aircraft grade of aluminum. Preferred aluminum alloys are well known to those skilled in fabricating or manufacturing lightweight items that require high strength and durability. For instance, aluminum alloy 2024 is widely used in aerospace applications and has a high yield strength and is a high-grade alloy with excellent fatigue resistance. Alternatively, aluminum alloy 2014 is also considered for use as it is known for its strength and toughness, but is susceptible to corrosion, especially over long outdoor exposure. However, this particular alloy is preferred is because it is suitable for arc welding. Grade 6061 aluminum alloy is an alternative material considered for use in the present invention and is commonly used in lightweight applications requiring good strength, while being easy to machine and weld. Also alternatively, carbon fiber, titanium and steel are considered as potential materials for use in the component parts of the trekking crutch.

For this Detailed Description of Specific Embodiments, the terms “connected”, “attached”, “coupled” and “mounted” refer to any form of interaction between two or more elements, including mechanical, electrical, magnetic, electromagnetic, fluid, and thermal interaction. Two components may be functionally coupled with or to each other, even though they are not in direct contact with each other.

The word “embodiment” is used herein to mean “serving as an example, instance, or illustration.” Any embodiment described herein is not necessarily to be construed as preferred or advantageous over other embodiments. While the various aspects of the embodiments are presented in drawings, the drawings are not necessarily drawn to scale.

Additionally, reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that the above Detailed Description of Specific Embodiments includes the referenced figures and following claims, and is more simply referred to herein as the “description” or the “disclosure.” In this description, various features are sometimes grouped together in a single embodiment, figure, or written explanation thereof for the purpose of streamlining this disclosure. However, this method of disclosure is not to be interpreted as reflecting an intention that any claim require more features than those expressly recited in that claim. Rather, as the following claims reflect, inventive aspects are exhibited in a combination of fewer than all features of any single foregoing disclosed embodiment. Thus, the claims following this description are hereby expressly incorporated into this description and disclosure, with each claim standing on its own as a separate embodiment. Additionally, this description includes all permutations of the independent claims with their dependent claims.

Also, the terms “substantially”, and “approximately” or “approximate” are employed herein throughout, including this detailed description and the attached claims, with the understanding that is denotes a level of exactitude commensurate with the skill and precision typical for the particular field of endeavor, as applicable.

Additionally, the terminology used in this Detailed Description of Specific Embodiments is to be interpreted according to ordinary and customary usage in the field of the invention as exemplified in the pertinent U.S. and International Patent Classification Codes, and equivalent codes in other patent classification systems.

In compliance with the statutes, the invention has been described in language more or less specific as to structural features and process steps where applicable. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

What is claimed is:

1. A trekking crutch apparatus comprising:
an underarm member having an underarm cross-bar with an underarm cushion mounted on the underarm cross-bar, and the underarm cross-bar receivable into an armpit of a user;
the underarm cross-bar of the underarm member supported by an underarm first side support-bar, opposite an underarm second side support-bar, and the underarm first side support-bar and the underarm second side support-bar extend from the underarm cross-bar and the underarm first side support-bar and the underarm second side support-bar join together at an underarm sleeve;
a handle member having a first hand-bar and a second hand-bar, the first hand-bar and the second hand-bar of the handle member joined together at an upper neck post, and the first hand-bar and the second hand-bar diverge as they extend from the upper neck post to receive a handgrip interconnected between a first handgrip connection on the first hand-bar and a second handgrip connection on the second hand-bar, with the handgrip graspable by the user;
the first hand-bar continues from the first handgrip connection and the second hand-bar continues from the second handgrip connection, and the first hand-bar converges with the second hand-bar to join together and to form a lower neck post;
the handle member removably connectable to the underarm member, the upper neck post of the handle member receivable into the underarm sleeve of the underarm member, the underarm member at an upper position of the trekking crutch when connected to the handle member, and the handle member at a middle position of the trekking crutch when connected to the underarm member;
a lower end member having a lower pole element removably receivable within a lower pole-bar, the lower pole-bar having lower pole mount opposite a lower neck sleeve, the lower pole element including a ground contact element, and the lower pole element received into and removably mounted to the lower pole-bar at the lower pole mount;
the lower end member removably connectable to the handle member, with the lower end member at a lower position of the trekking crutch, and the lower end post of the lower end member receivable into the lower neck sleeve of the handle member, the lower end member at a lower position of the trekking crutch when connected to the handle member.

2. The trekking crutch apparatus of claim 1, additionally wherein:
said underarm member includes a set of underarm coupling holes located proximate to said underarm sleeve, and said upper neck-post of the handle member includes an upper handle coupling hole, and when the upper neck-post is received into the underarm sleeve, one of the set of underarm holes aligns with the upper handle coupling hole to create an upper aligned hole pair; and
an upper spring-clip is inserted through the upper aligned hole pair to secure an underarm attachment between the underarm member and the handle member.

3. The trekking crutch apparatus of claim 1, additionally wherein:
said lower pole-bar of the lower end member includes a set of lower bar coupling holes, and said lower neck-post of the handle member includes an lower handle coupling hole, and when the lower neck-post is received into the lower neck sleeve, one of the set of lower bar coupling holes aligns with the lower member coupling hole to create a lower aligned hole pair; and
a lower spring-clip is inserted through the lower aligned hole pair to secure an lower member attachment between the lower member and the handle member.

4. The trekking crutch apparatus of claim 1, additionally wherein:
said underarm member includes a set of underarm coupling holes located proximate to said underarm sleeve, and the underarm member includes an upper handle button-hole located proximate to the upper neck sleeve of the underarm member;
the handle member includes an upper spring button located proximate to the upper neck post of the handle member; and
when the upper neck post is received into upper neck sleeve, the upper spring button is initially depressed to slide into the upper neck sleeve, and the upper spring button then extends into one of the set of underarm coupling holes to lock the upper neck post of the handle member into the upper neck sleeve of the underarm member.

5. The trekking crutch apparatus of claim 1, additionally wherein:
said lower pole-bar of the lower end member includes a set of lower bar coupling holes, and the lower end member includes a lower handle button-hole located proximate to the lower neck sleeve of the lower end member;
the handle member includes a lower spring button located proximate to the lower neck post of the handle member; and
when the lower neck post is received into lower neck sleeve, the lower spring button is initially depressed to slide into the lower neck sleeve, and the lower spring button then extends into one of the set of lower bar coupling holes to lock the lower neck post of the handle member into the lower neck sleeve of the lower end member.

6. The trekking crutch apparatus of claim 1, additionally wherein:
said underarm member includes a center support-bar;
the center support-bar, said underarm first side support-bar and said underarm second side support-bar extend from the underarm cross-bar, and the underarm first side support-bar and the underarm second side support-bar join together at said underarm sleeve, and said underarm sleeve of the underarm member is included in the center support-bar; and
said upper neck post of the handle member receivable into said underarm sleeve of the underarm member, is further receivable into the underarm center support-bar.

7. The trekking crutch apparatus of claim 6, additionally wherein:
said center support-bar of the underarm member includes a set of underarm coupling holes located proximate to said underarm sleeve, and said upper neck-post of the handle member includes an upper handle coupling hole, and when the upper neck-post is received into the underarm sleeve, one of the set of underarm coupling holes aligns with the upper handle coupling hole to create an upper aligned hole pair; and
an upper spring-clip is inserted through the upper aligned hole pair to secure an underarm attachment between the underarm member and the handle member.

8. The trekking crutch apparatus of claim 6, additionally wherein:
said center support-bar of the underarm member includes a set of underarm coupling holes located proximate to said underarm sleeve, and the underarm member includes an upper handle button-hole located proximate to the upper neck sleeve of the underarm member;
the handle member includes an upper spring button located proximate to the upper neck post of the handle member; and
when the upper neck post is received into upper neck sleeve, the upper spring button is initially depressed to slide into the upper neck sleeve, and the upper spring button then extends into one of the set of underarm coupling holes to lock the upper neck post of the handle member into the upper neck sleeve of the underarm member.

9. The trekking crutch apparatus of claim 1, additionally wherein:
said lower pole element removably receivable within the lower pole-bar includes a ski-basket with an end tip, and the end tip is said ground contact element.

10. The trekking crutch apparatus of claim 1, additionally wherein said underarm member, said handle member and said lower pole-bar of the trekking crutch are formed substantially of a hollow cylindrical tubing.

11. A trekking crutch apparatus comprising:
an underarm member having an underarm cross-bar with an underarm cushion mounted on the underarm cross-bar, and the underarm cross-bar receivable into an armpit of a user;
the underarm cross-bar of the underarm member supported by an underarm first side support-bar, opposite an underarm second side support-bar and the underarm cross-bar of the underarm member is supported by an underarm center support-bar positioned between the underarm first side support-bar and the underarm second side support-bar, and the underarm center support-bar, the underarm first side support-bar and the underarm second side support-bar extend from the underarm cross-bar and all join together at an underarm sleeve;
a handle member having a first hand-bar and a second hand-bar, the first hand-bar and the second hand-bar of the handle member joined together at an upper neck post, and the first hand-bar and the second hand-bar diverge as they extend from the upper neck post to receive a handgrip interconnected between a first handgrip connection on the first hand-bar and a second handgrip connection on the second hand-bar, with the handgrip graspable by the user;
the first hand-bar continues from the first handgrip connection and the second hand-bar continues from the second handgrip connection, and the first hand-bar converges with the second hand-bar to join together and to form a lower neck post;
the handle member removably connectable to the underarm member, the upper neck post of the handle member receivable into the underarm sleeve of the underarm member, the underarm member at an upper position of the trekking crutch when connected to the handle member, and the handle member at a middle position of the trekking crutch when connected to the underarm member;
a lower end member having a lower pole element removably receivable within a lower pole-bar, the lower pole-bar having lower pole mount opposite a lower neck sleeve, the lower pole element including a ground contact element, and the lower pole element received into and removably mounted to the lower pole-bar at the lower pole mount;
the lower end member removably connectable to the handle member, with the lower end member at a lower position of the trekking crutch, and the lower end post of the lower end member receivable into the lower neck sleeve of the handle member, the lower end member at a lower position of the trekking crutch when connected to the handle member.

12. The trekking crutch apparatus of claim 11, additionally wherein said upper neck post of the handle member receivable into said underarm sleeve of the underarm member, is further receivable into said underarm center support-bar of the underarm member.

13. The trekking crutch apparatus of claim 12, additionally wherein:
said underarm center support-bar of the underarm member includes a set of underarm coupling holes, and said upper neck-post of the handle member includes an upper handle coupling hole, and when the upper neck-post is received into the underarm sleeve, one of the set of underarm coupling holes aligns with the upper handle coupling hole to create an upper aligned hole pair; and
an upper spring-clip is inserted through the upper aligned hole pair to secure an underarm attachment between the underarm member and the handle member.

14. The trekking crutch apparatus of claim 11, additionally wherein:
said lower pole-bar of the lower end member includes a set of lower bar coupling holes, and said lower neck-post of the handle member includes an lower handle coupling hole, and when the lower neck-post is received into the lower neck sleeve, one of the set of lower bar coupling holes aligns with the lower member coupling hole to create a lower aligned hole pair; and
a lower spring-clip is inserted through the lower aligned hole pair to secure an lower member attachment between the lower member and the handle member.

15. The trekking crutch apparatus of claim 11, additionally wherein:
said underarm center support-bar of the underarm member includes a set of underarm coupling holes, and the underarm member includes an upper handle button-hole located proximate to the upper neck sleeve of the underarm member;
the handle member includes an upper spring button located proximate to the upper neck post of the handle member; and
when the upper neck post is received into upper neck sleeve, the upper spring button is initially depressed to slide into the upper neck sleeve, and the upper spring button then extends into one of the set of underarm coupling holes to lock the upper neck post of the handle member into the upper neck sleeve of the underarm member.

16. The trekking crutch apparatus of claim 11, additionally wherein:
said lower pole-bar of the lower end member includes a set of lower bar coupling holes, and the lower end member includes a lower handle button-hole located proximate to the lower neck sleeve of the lower end member;
the handle member includes a lower spring button located proximate to the lower neck post of the handle member; and
when the lower neck post is received into lower neck sleeve, the lower spring button is initially depressed to slide into the lower neck sleeve, and the lower spring button then extends into one of the set of lower bar coupling holes to lock the lower neck post of the handle member into the lower neck sleeve of the lower end member.

17. The trekking crutch apparatus of claim 11, additionally wherein:
said lower pole element removably receivable within the lower pole-bar includes a ski-basket with an end tip, and the end tip is said ground contact element.

18. The trekking crutch apparatus of claim 11, additionally wherein said underarm member, said handle member and said lower pole-bar of the trekking crutch are formed substantially of a hollow cylindrical tubing.
